(19) United States
(12) Patent Application Publication
(10) Pub. No.: US 2002/0163899 A1
(43) Pub. Date: Nov. 7, 2002

(54) Method for transmitting packet data

(75) Inventor: Chao-Yin Liu, Hsinchu (TW)

Correspondence Address: Edwards & Angell, LLP, Dike, Bronstein, Roberts & Cushman, 130 Water Street, Boston, MA, 02109-4280, US

(73) Assignee: Winbond Electronics Corp., Hsinchu (TW)

(21) Appl. No.: 09/962,595

(22) Filed: Sep. 25, 2001

(30) Foreign Application Priority Data
May 4, 2001 (TW) 090110784

(51) Int. Cl. H04B 7/212; H04J 3/24

(52) U.S. Cl. 370/337; 370/473

(57) ABSTRACT

A method for transmitting a packet data applied in a digital European cordless telecommunication system is disclosed. The method includes steps of providing a server, providing a plurality of receivers including a voice receiver and a data receiver, providing a plurality of frames for transmitting a continuously lining-up voice signals including a first and a second voice signals and a plurality of packet data, wherein each the frame including a plurality of time slots, searching at least one voice communicating time slot from the plural time slots, saving a buffer voice signal in a registering device, wherein the buffer voice signal is the first voice signal after transmitting, and transmitting the plural packet data by the voice communicating time slot. The communicating time slot transmits plural packet data to a particular receiver and simultaneously plays the buffer voice signal to one of the plural receivers including the communicating time slot.

### FIELD OF THE INVENTION

The present invention relates to a method for transmitting a packet data, and more particularly to a method for transmitting a packet data applied in a time division multiple access (TDMA) system.

### BACKGROUND OF THE INVENTION

Generally, a digital wireless telecommunication system using a time division multiple access (TDMA) transmission is to divide the radis frequency to multiple time slots for being distributed to multiple receivers to use. Furthermore, using different time slots, a voice and data services can be provided at the same time. However, because the voice service requires to be provided at real time, the data service only can be transmitted via the time slots which are not used for the voice service. Hence, when the system has a large number of voice loadings, the data service is forced to decrease the transmission bandwidth.

For typical voice-and-data transmission technology, a voice detector is used to detect the intervals of the voice transmission and a packet data is transmitted via the voice channel when the period is not used to transmit the voice. The advantage of the typical transmission technology is not affecting the voice communication quality. However, the typical transmission technology requires the more complicated design and the voice channel thereof is limited to oneself. Hence, the amount of the data transmission is limited. Thus, for a system resource shared by multiple users, it is a critical issue to increasing the transmission rate and not affecting the transmission quality in the system.

Therefore, the purpose of the present invention is to develop a method to deal with the above situations encountered in the prior art.

### SUMMARY OF THE INVENTION

It is therefore an object of the present invention to propose a method for transmitting a packet data applied in a digital European cordless telecommunication (DECT) system for efficiently increasing a transmission rate and not affecting a communication quality.

It is therefore another object of the present invention to propose a method for transmitting a packet data applied in a time division multiple access (TDMA) system for efficiently increasing a transmission rate and not affecting a communication quality.

According to the present invention, there is provided a method for transmitting a packet data applied in a digital European cordless telecommunication (DECT) system. The method includes steps of providing a server, providing a plurality of receivers, providing a plurality of frames for transmitting a continuously lining-up voice signals including a first and a second voice signals and a plurality of packet data, wherein each frame including a plurality of time slots, searching at least one voice communicating time slot from the plural time slots, storing a buffer voice signal in a registering device, wherein the buffer voice signal is the first voice signal after transmitting, and transmitting the plural packet data by the voice communicating time slot. The voice communicating time slot transmits plural packet data to a particular receiver and simultaneously plays the buffer voice signal to one of the plural receivers including the voice communicating time slot, for accelerating a transmission rate. The plural receivers include a voice receiver and a data receiver.

Preferably, the server transmits the plural data to the plural receivers by a downlink direction.

Certainly, the voice communicating time slot can be a standby time slot.

Preferably, after transmitting the plural packet data, the buffer voice signal is deleted by the registering device and the second voice signal is saved in the registering device.

Preferably, the registering device is a buffer.

Preferably, the continuously lining-up voice signals include at least two voice signals.

According to the present invention, there is provided a method for transmitting a packet data applied in a time division multiple access (TDMA) system. The method includes steps of providing a plurality of time slots for simultaneously transmitting a continuously lining-up voice signals comprising a first and a second voice signals and a plurality of packet data, storing a buffer voice signal in a registering device, wherein the buffer voice signal is the first voice signal after transmitting and playing the buffer voice signal and simultaneously transmitting the plural packet data for accelerating a transmission rate.

Preferably, the method is applied in a digital European cordless telecommunication (DECT) system. Preferably, the digital European cordless telecommunication (DECT) system is employed a server transmitting to a plurality of receivers by a downlink direction. The plural voice signals and the plural packet data are preferably transmitted between the server and the plural receivers by a plurality of frames. Certainly, each frame includes the plural time slots.

Preferably, when the plural packet data is transmitted to a particular data receiver, the buffer voice signal is played in the voice receiver, simultaneously.

According to the present invention, there is provided a method for transmitting a packet data applied in a time division multiple access (TDMA) system. The method includes steps of providing a server, providing a plurality of receivers, providing a plurality of frames for transmitting a continuously lining-up voice signals comprising a first and a second voice signals and a plurality of packet data, wherein each frame including a plurality of time slots, searching at least one voice communicating time slot from the plural time slots, and transmitting the plural packet data by the voice communicating time slot, for accelerating a transmission rate. The plural receivers include a voice receiver and a data receiver.

The present invention may best be understood through the following description with reference to the accompanying drawings, in which:

### BRIEF DESCRIPTION OF THE DRAWINGS

FIG. 1 is a diagram illustrating a frame structure of a digital European cordless telecommunication (DECT) system according to a preferred embodiment of the present invention;

FIG. 2 is a diagram illustrating a time slot in the frame of the digital European cordless telecommunication (DECT) system in FIG. 1;

FIG. 3 is a diagram illustrating an A-field header structure of the digital European cordless telecommunication (DECT) system according to a preferred embodiment of the present invention;

FIG. 4 is a diagram illustrating a BA-subfield table of the digital European cordless telecommunication (DECT) system according to a preferred embodiment of the present invention;

FIG. 5 is flow chart illustrating a communication protocol of the digital European cordless telecommunication (DECT) system according to a preferred embodiment of the present invention; and

FIG. 6 is a diagram illustrating a voice-receiving device at a voice receiver in the digital European cordless telecommunication (DECT) system according to a preferred embodiment of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

The present invention is applied in that a server transmits data to a receiver in a down link direction. Therefore, a digital European cordless telecommunication (DECT) system is used to be an example for describing the present invention in detail.

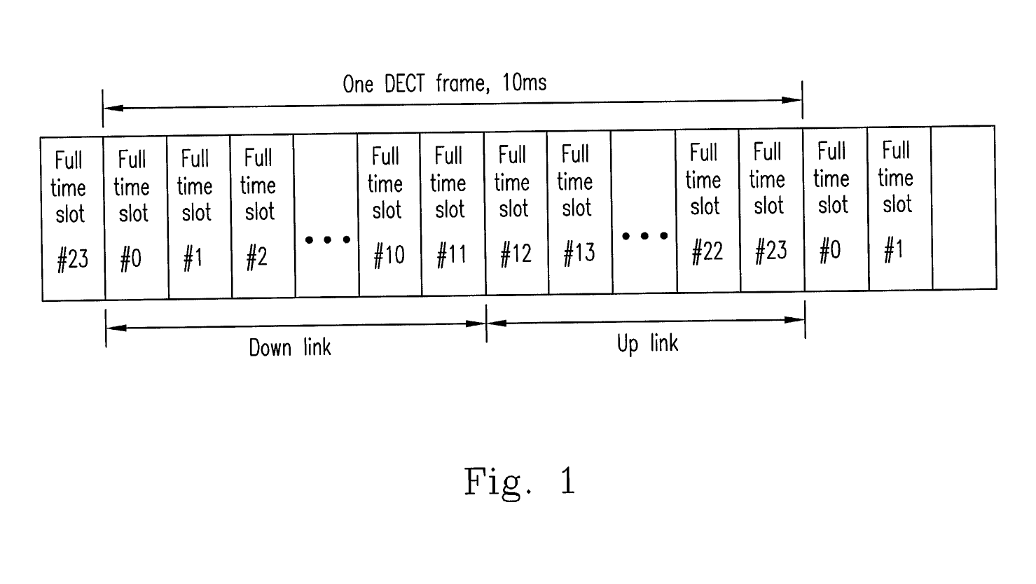

FIG. 1 is a diagram illustrating a frame structure of the digital European cordless telecommunication (DECT) system according to a preferred embodiment of the present invention. The DECT is one of European cordless telecommunication standards and is a time division multiple access (TDMA) standard. A frame of the DECT system is divided to 24 time slots as shown in FIG. 1. Generally, the 24 time slots are designed as 12 full duplex bearers, i.e. 12 time slots are used for up link communicating and 12 time slots are used for down link communicating.

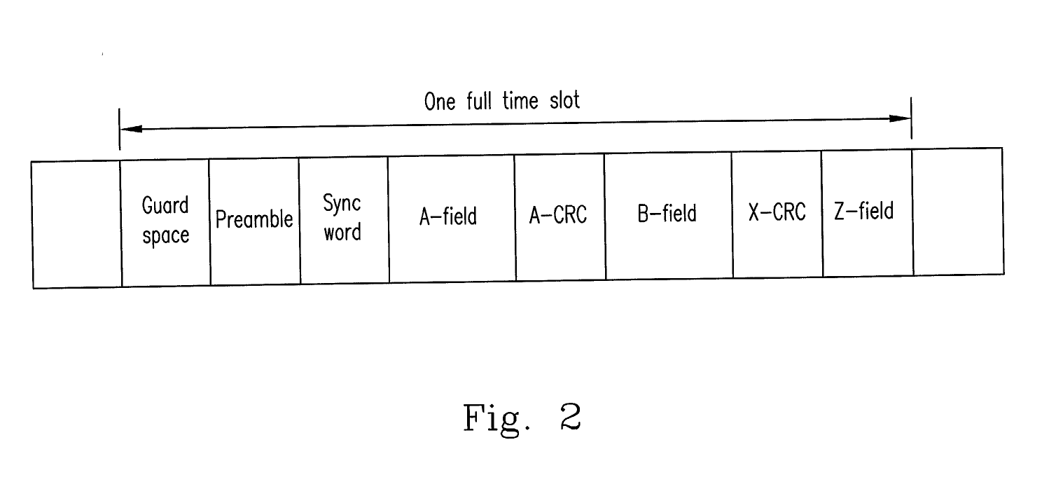

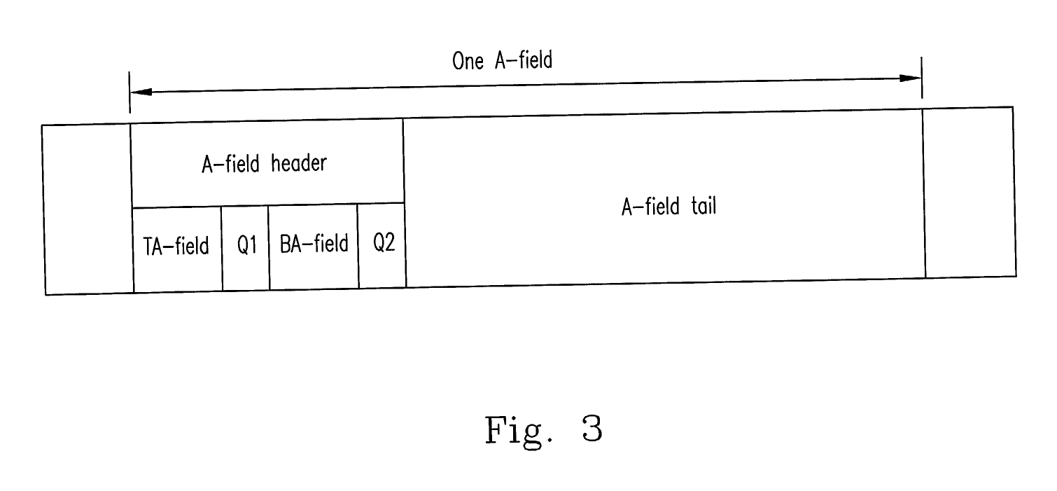

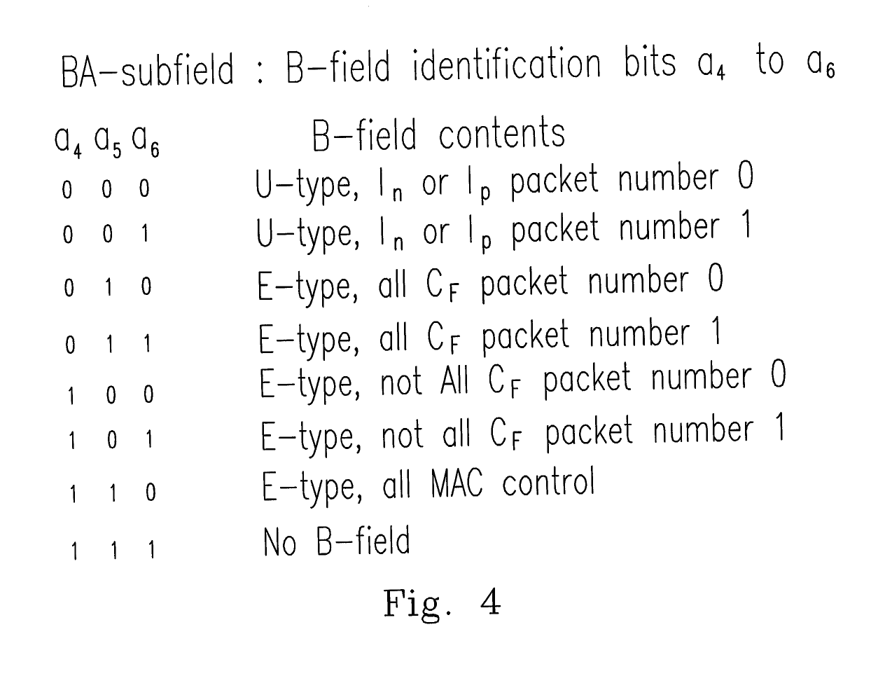

As shown in FIG. 2, each time slot in the DECT system including a guard space, a preamble, a synchronous word (SyncWord), an A-field, an A-cyclical redundancy check code (A-CRC), a B-field, a X-cyclical redundancy check code (X-CRC) and a Z-field. The A-field provides 48 bits for a digital European cordless telecommunication (DECT) protocol control signal and the B-field provides 320 bits for being a voice/data/advance control signal. The A-field is divided to an A-header and a A-tail, and the A-header is further divided to a TA-subfield, a BA-subfield, a Q₁ and a Q₂ control bits as shown in FIG. 3. As shown in FIG. 4, the BA-subfield including identification bits of a₄ to a₆ for determine the B-field content. For the DECT system, generally, the voice is transmitted by U-type or I_{N} format while the data is transmitted by E-type format. The method according to the present invention is performed by the BA-subfield for controlling the voice or data transmission.

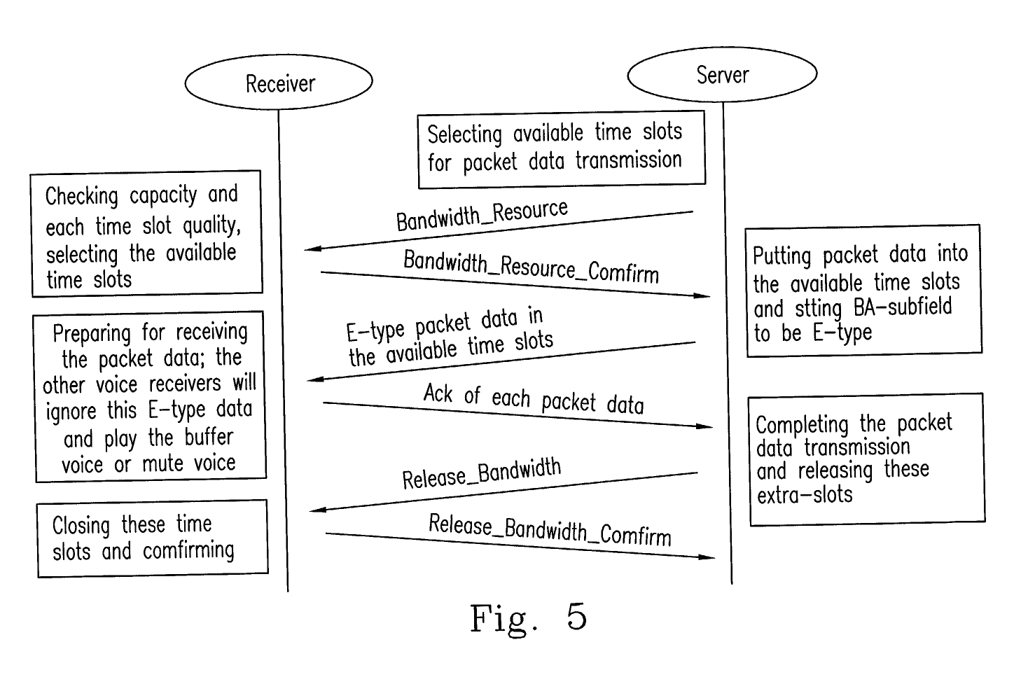

FIG. 5 is flow chart illustrating a telecommunication protocol of the digital European cordless telecommunication (DECT) system according to a preferred embodiment of the present invention. The telecommunication procedure is described as the following:

1. First, a server is on-line with a receiver according to the typical DECT protocol and the type for transmitting data is set. Sequentially, the server searches current standby time slots and voice communicating time slots and selects available time slots according to the requirement of the datastream and informs to the receiver that which time slots can use <Bandwidth_Resource>.

2. After receiving <Bandwidth_Resource> signal, the receiver check capability and each time slot quality to select available time slots, return a confirm signal of <Bandwidth_Resource_Confirm> to the server, and prepare ready for receiving the down link data packets in the available time slots.

3. When the server receives the confirm signal of <Bandwidth_Resource_Confirm>, the packet data is put into the available time slots confirmed by the receiver and the BA-subfield of the available time slots is set to be E-type.

4. The assigned receiver will receive the packet packets on these available time slots. While the receivers are voice communicating, will automatically ignore the packet data and play the buffer voice to the user instead.

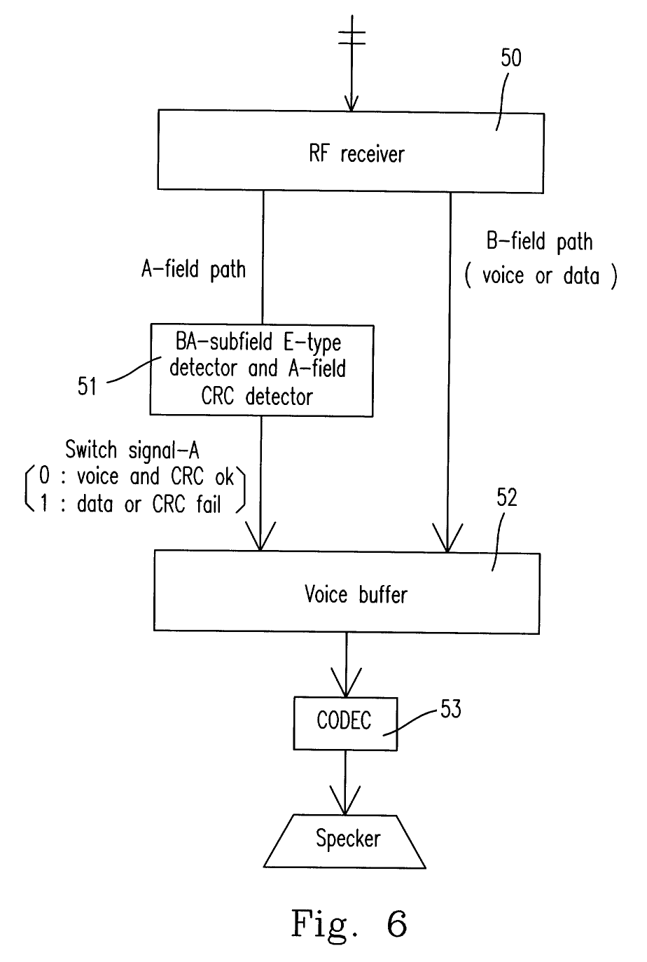

The present invention includes a server and a plurality of receivers, wherein these receivers can transmit/receive voice or data to/from the server through a pair duplex time slot in one frame. The receiver is active to receive the voice, called voice receiver, while the receiver is active to receive the packet data, called data receiver. FIG. 6 is a diagram illustrating a voice-receiving device at a voice receiver in the digital European cordless telecommunication (DECT) system according to a preferred embodiment of the present invention. As shown in FIG. 6, when the voice receiver, e.g. RF receiver 50, receives a signal, the signal will pass through both A-field path and B-field path. First, in the A-field path, the signal will be determined to be a voice or a packet data signal by a BA-subfield E-type detector and an A-field CRC detector 51. Then, a switch signal-A is output to control a voice buffer 52. If the signal is a voice, the voice from the B-field path is saved into the voice buffer 52 and passed to a CODEC 53 simultaneously. Sequentially, the voice signal is played by the CODEC 53. On the other hand, if the signal is packet data which BA-field is E-type, the B-field path is broken and a buffer voice in the voice buffer 52 is passed to the CODEC 53. That is, when receiving the packet data, the voice receiver will ignore the packet data and play the voice buffer 52 by CODEC 53 or mute the voice.

In addition, for a data receiver, the data receiver does not have the voice-receiving device shown in FIG. 6. Thus, the data receiver will directly save the packet data into a data buffer. Furthermore, the data receiver can receive data from multiple slots in one frame. Those slots are assigned via the protocol procedure shown in FIG. 5.

Therefore, the present invention provides the method for transmitting the packet data applied in the digital European cordless telecommunication (DECT) system or the time division multiple access (TDMA) system. The method includes steps of providing a server, providing a plurality of receivers, providing a plurality of frames for transmitting a continuously lining-up voice signals including a first and a second voice signals and a plurality of packet data, searching at least one communicating time slot from the plural time slots, storing a buffer voice signal, which is the first voice signal after transmitting, in a registering device, and transmitting the plural packet data by the at least one communicating time slot. Each frame includes a plurality of time slots. When the communicating time slot transmits plural packet data to a particular receiver, the buffer voice is simultaneously played to one receiver including the communicating time slot. Furthermore, after transmitting the plural packet data, the buffer voice signal is deleted by the registering device and the second voice signal is saved in the registering device. In addition, the continuously lining-up voice signals can include a plurality of voice signals.

In addition, according to the present invention, when the data packet is transmitted by one frame interval and not more than 200 ms, the sense of hearing for the user has the minimum effect. Furthermore, the receiver can receive 2800 bytes in 200 ms, which is equal to 112 Kbps burst transmission rate. Comparing with the prior art, i.e. using a single time slot, with a transmission rate of 32 Kbps, the present invention can triply increase the transmission rate.

In sum, the method for transmitting the data packet according to the present invention can efficiently increase the transmission rate and not affecting a communication quality for solving the slowly transmitting problem. In addition, the method for transmitting the data packet according to the present invention also has the advantage of easily implementation. Therefore, it is valuable for the industry.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for transmitting a packet data applied in a digital European cordless telecommunication (DECT) system, comprising steps of: providing a server;
providing a plurality of receivers including a voice receiver and a data receiver;
providing a plurality of frames for transmitting a continuously lining-up voice signals comprising a first and a second voice signals and a plurality of packet data, wherein each said frame including a plurality of time slots;
searching at least one voice communicating time slot from said plural time slots;
storing a buffer voice signal in a registering device, wherein said buffer voice signal is said first voice signal; and
transmitting said plural packet data by said at least one communicating time slot, wherein said at least one voice communicating time slot transmits plural packet data to a particular data receiver and simultaneously plays said buffer voice signal to one of said plural receivers including said at least one communicating time slot, for accelerating a transmission rate.

2. The method according to claim 1 wherein said server transmits said plural data to said plural receivers by a downlink direction.

3. The method according to claim 1 wherein said voice communicating time slot is a standby time slot.

4. The method according to claim 1 wherein after transmitting said plural packet data, said buffer voice signal is deleted by said registering device and said second voice signal is saved in said registering device.

5. The method according to claim 1 wherein said registering device is a buffer.

6. The method according to claim 1 wherein said continuously lining-up voice signals includes at least two voice signals.

7. The method according to claim 1 wherein said voice receiver is active to receive voice.

8. The method according to claim 1 wherein said data receiver is active to receive data.

9. A method for transmitting a packet data applied in a time division multiple access (TDMA) system, comprising steps of:
providing a plurality of time slots for simultaneously transmitting a continuously lining-up voice signals comprising a first and a second voice signals and a plurality of packet data;
storing a buffer voice signal in a registering device, wherein said buffer voice signal is said first voice signal; and
playing said buffer voice signal and simultaneously transmitting said plural packet data for accelerating a transmission speed.

10. The method according to claim 9 wherein said method is applied in a digital European cordless telecommunication (DECT) system.

11. The method according to claim 10 wherein said digital European cordless telecommunication (DECT) system is employed a server transmitting to a plurality of receivers including a voice receiver and a data receiver by a downlink direction.

12. The method according to claim 11 wherein said plural voice signals and said plural packet data are transmitted between said server and said plural receivers by a plurality of frames.

13. The method according to claim 12 wherein each said frame includes said plural time slots.

14. The method according to claim 11 wherein when said plural packet data is transmitted to a particular data receiver, said buffer voice signal is played in a voice receiver, simultaneously.

15. A method for transmitting a packet data applied in a time division multiple access (TDMA) system, comprising steps of:
providing a server;
providing a plurality of receivers including a voice receiver and a data receiver;
providing a plurality of frames for transmitting a continuously lining-up voice signals comprising a first and a second voice signals and a plurality of packet data, wherein each said frame including a plurality of time slots;
searching at least one voice communicating time slot from said plural time slots; and
transmitting said plural packet data by said communicating time slot, for accelerating a transmission speed.
